(19) United States
(12) Patent Application Publication
(10) Pub. No.: US 2022/0112363 A1
(43) Pub. Date: Apr. 14, 2022

(54) POLYMER PROCESSING AIDS (PPA) FOR BLENDING WITH POLYETHYLENE DURING BLOWN FILM EXTRUSION

(71) Applicant: Dow Global Technologies LLC, Midland, MI (US)

(72) Inventors: Fawzi G. Hamad, Pearland, TX (US); Scott T. Matteucci, Midland, MI (US); Kyle E. Hart, Manvel, TX (US); Arnaldo T. Lorenzo, Tarragona (ES); Gregory F. Meyers, Midland, MI (US); Kenneth L. Kearns, JR., Midland, MI (US); Jianbo Hou, Midland, MI (US)

(73) Assignee: Dow Global Technologies LLC, Midland, MI (US)

(21) Appl. No.: 17/420,758

(22) PCT Filed: Jan. 7, 2020
(86) PCT No.: PCT/US2020/012537

§ 371 Date: Jul. 6, 2021

Related U.S. Application Data
(60) Provisional application No. 62/789,198, filed on Jan. 7, 2019.

(51) Int. Cl. C08L 23/08; C08J 5/18

(52) U.S. Cl. CPC C08L 23/0815; C08J 5/18; C08L 2203/16; C08J 2471/02; C08J 2323/08; C08J 2427/16; C08L 2205/035

(57) ABSTRACT

Embodiments are directed to compositions comprising at least one polyethylene (PE) having a density ranging from 0.850 g/cc to 0.970 g/cc, and a polymer processing aid (PPA) masterbatch comprising a PPA polymer blend, at least one polymeric carrier, and optionally up to 12 wt. % of one or more inorganic materials. The PPA polymer blend comprises from 40 to 60 wt. % of one or more fluoroelastomers, and from 40 to 60 wt. % of polyethylene glycol. The composition further comprises at least one fragrance oil. The composition is defined by the equation: RED (_{PE-PPA masterbatch})<RED (_{Fragrance oil-PPA masterbatch}), wherein the RED (_{PE-PPA masterbatch}) is the relative energy difference (RED) value for the PE and PPA masterbatch and RED (_{Fragrance oil-PPA masterbatch}) is the RED value for the fragrance oil and PPA masterbatch.

### CROSS REFERENCE TO RELATED APPLICATIONS

This application claims priority to U.S. Provisional Patent Application No. 62/789,198, filed on Jan. 7, 2019, the entire disclosure of which is hereby incorporated by reference.

### TECHNICAL FIELD

Embodiments described herein relate generally to polymer processing aids, and more particularly relate to polymer processing aids for blending with polyethylene that help to reduce melt fracture during blown film extrusion.

### BACKGROUND

Melt fracture is an undesired phenomenon that typically happens during blown film extrusion due to the high stresses involved. Melt fracture can occur for two reasons One, the polymer melt begins to stick and slip against the metal surface in the die. The alternation in stick/slip causes a continuous rise/drop of melt pressure, respectively, consequently leading to the formation of melt fracture on the surface of the film. Two, as the polymer exits the die, it swells and is simultaneously pulled upwards by the nip, which could lead to the polymer film getting stretched too quickly when leaving the die. When the film is quenched too quickly during stretching, this can lead to tears on the surface of the film, also known as melt fracture.

Melt fracture severity can depend on several factors such as molecular weight of the polyethylene extruded as well as the processing condition. For certain applications, high molecular weights and high processing output speeds are necessary; however, these are both culprits that can exacerbate the amount of melt fracture observed in the film. To help eliminate melt fracture in these types of conditions, polymer processing aids (PPA) are blended together with the polyethylene to coat the metal surfaces in the extruder and the die. Fluoroelastomer is a type of PPA commonly used.

When the PPA and polyethylene are blended together, the fluoroelastomer migrates in the polymer melt matrix to the surface to coat the metal. Typically, in blown film extrusion, several other additives are blended depending on the market application. These additives interact and interfere with the PPA, thereby making it less effective at coating the metal surface and hence causes melt fracture. Interaction or interference with the PPA could be caused by additives competing with the PPA to coat the metal surface or additives solubilizing the PPA and thereby nullifying its effectiveness.

One such additive that may interfere with the PPA is an oil masterbatch. In some market applications, such as trash liners, fragrance oil masterbatches are a blended ingredient that provides the final product with a pleasant scent that masks the odors generated by the collected trash. However, in some cases, the fluoroelastomer may interact with the oils, which thereby reduces the effectiveness of PPA in its ability to coat the metal surface, and hence leads to the formation of melt fracture.

Accordingly, an improved PPA which eliminates or reduces melt fracture is desired.

### SUMMARY

Embodiments of the present disclosure meet those needs by utilizing a different type of PPA with higher affinity to the polyethylene matrix compared to the fragrance oils is needed. One metric for making this determination is by comparing the relative energy difference (RED) of the PPA to both the polyethylene (PE) and the fragrance oil. In the present embodiments, PPA affinity to the PE and the fragrance oil is defined by the following equation:

RED (_{PE-PPA Masterbatch})<RED (_{Fragrance Oil-PPA Masterbatch})

wherein the RED (_{PE-PPA Masterbatch}) is the RED value for the PE and PPA masterbatch and RED (_{Fragrance Oil-PPA Masterbatch}) is the RED value for the fragrance oil and PPA masterbatch.

Without being bound by theory, when the PPA has a lower RED for the fragrance oil than the PE, the PPA is stabilized or otherwise interacts with the fragrance oil such that the PPA is not able to effectively migrate to the polymer/melt processing equipment interface. This restricted migration renders the PPA less effective. Conversely, when the PPA is more soluble in the polyethylene matrix than the oil as demonstrated by a higher RED for the fragrance oil than the PE, the PPA is desirably able to migrate to the interface with less interference from the fragrance oil.

The present PPA embodiments contain a sufficient amount of fluoroelastomer to reduce issues with shear at the extrusion die head. Moreover, blending polyethylene glycol with the fluoroelastomer may further improve the RED (_{PE-PPA Masterbatch})<RED (_{Fragrance Oil-PPA Masterbatch}) behavior. As such, the present PPA embodiments include a blend comprising 40 to 60 wt % fluoroelastomer, 40 to 60 wt % polyethylene glycol, and inorganic materials such as talc, calcium carbonate, and/or magnesium oxide.

According to at least one composition embodiment of the present disclosure, the composition comprises at least one polyethylene (PE) having a density ranging from 0.850 g/cc to 0.970 g/cc, and a polymer processing aid (PPA) masterbatch comprising a PPA polymer blend, at least one polymeric carrier, and optionally up to 12 wt. % of one or more inorganic materials. The PPA polymer blend comprises from 40 to 60 wt. % of one or more fluoroelastomers, and from 40 to 60 wt. % of polyethylene glycol. The composition further comprises at least one fragrance oil. The composition is defined by the equation: RED (_{PE-PPA masterbatch})<RED (_{Fragrance Oil-PPA masterbatch}), wherein the RED (_{PE-PPA masterbatch}) is the relative energy difference (RED) value for the PE and PPA masterbatch and RED (_{Fragrance Oil-PPA masterbatch}) is the RED value for the fragrance oil and PPA masterbatch.

These and other embodiments are described in more detail in the following Detailed Description.

### DETAILED DESCRIPTION

Specific embodiments of the present application will now be described. The disclosure may, however, be embodied in different forms and should not be construed as limited to the embodiments set forth in this disclosure. Rather, these embodiments are provided so that this disclosure will be thorough and complete, and will fully convey the scope of the subject matter to those skilled in the art.

### Definitions

The term “polymer” refers to a polymeric compound prepared by polymerizing monomers, whether of the same or a different type. The generic term polymer thus embraces the term “homopolymer,” usually employed to refer to polymers prepared from only one type of monomer as well as “copolymer” which refers to polymers prepared from two or more different monomers. The term “interpolymer,” as used herein, refers to a polymer prepared by the polymerization of at least two different types of monomers. The generic term interpolymer thus includes copolymers, and polymers prepared from more than two different types of monomers, such as terpolymers.

“Polyethylene” or “ethylene-based polymer” shall mean polymers comprising greater than 50% by mole of units which have been derived from ethylene monomer. This includes polyethylene homopolymers or copolymers (meaning units derived from two or more comonomers). Common forms of polyethylene known in the art include Low Density Polyethylene (LDPE); Linear Low Density Polyethylene (LLDPE); Ultra Low Density Polyethylene (ULDPE); Very Low Density Polyethylene (VLDPE); single-site catalyzed Linear Low Density Polyethylene, including both linear and substantially linear low density resins (m-LLDPE); Medium Density Polyethylene (MDPE); and High Density Polyethylene (HDPE).

“Multilayer structure” means any structure having more than one layer. For example, the multilayer structure may have two, three, four, five or more layers. A multilayer structure may be described as having the layers designated with letters. For example, a three layer structure having a core layer B, and two external layers A and C may be designated as A/B/C. Likewise, a structure having two core layers B and C and two external layers A and D would be designated A/B/C/D.

Reference will now be made in detail to embodiments of the present disclosure. In one embodiment, the composition Embodiments are directed to compositions comprising at least one polyethylene (PE) having a density ranging from 0.850 g/cc to 0.970 g/cc, and a polymer processing aid (PPA) masterbatch comprising a PPA polymer blend, at least one polymeric carrier, and optionally up to 12 wt. % of one or more inorganic materials. The PPA polymer blend comprises from 40 to 60 wt. % of one or more fluoroelastomers, and from 40 to 60 wt. % of polyethylene glycol. The composition further comprises at least one fragrance oil. The composition is defined by the equation: RED (_{PE-PPA masterbatch})<RED (_{Fragrance Oil-PPA masterbatch}), wherein the RED (_{PE-PPA masterbatch}) is the relative energy difference (RED) value for the PE and PPA masterbatch and RED (_{Fragrance Oil-PPA masterbatch}) is the RED value for the fragrance oil and PPA masterbatch.

PPA Polymer Masterbatch

Various amounts of the PPA polymer masterbatch are contemplated within the composition. In one or more embodiments, the composition may comprise from 100 to 2,000 ppm of the PPA, or from 250 to 2,000 or from 500 to 2,000, or from 500 to 1,500 of the PPA polymer masterbatch.

As stated above, the PPA polymer blend comprises fluoroelastomers, which may encompass various compositions. For example, fluorinated monomers which may be copolymerized to yield suitable fluoroelastomers include vinylidene fluoride, hexafluoropropylene, chlorotrifluoroethylene, tetrafluoroethylene and perfluoroalkyl perfluorovinyl ethers. Specific examples of the fluoroelastomers which may be employed include copolymers of vinylidene fluoride and a comonomer selected from hexafluoropropylene, chlorotrifluoroethylene, 1-hydropentafluoropropylene, and 2-hydropentafluoropropylene. In a specific embodiment, the fluoroelastomer comprises a copolymer of vinylidene fluoride and hexafluoropropylene.

For these copolymers, it is understood that the amounts of monomer and comonomer may vary within the fluoroelastomer. For example, the copolymer of vinylidene fluoride and hexafluoropropylene may comprise from 70 mole % to 85 mole % of vinylidene fluoride monomer and from 15 mole % to 30 mole % of hexafluoropropylene monomer. In further embodiments, the copolymer of vinylidene fluoride and hexafluoropropylene monomers may comprises from 73 to 83 mole % of vinylidene fluoride and from 17 to 27 mole % of hexafluoropropylene.

Moreover, various compositions are contemplated for the polyethylene glycol within the PPA polymer blend. For example, the polyethylene glycol may be have a molecular weight of 100 g/mol to 25,000 g/mol, or from 1000 g/mol to 20,000 g/mol, or from or from 5000 g/mol to 10,000 g/mol.

The PPA polymer blend comprises from 40 to 60 wt. %, or from 45 to 55 wt. %, based on the total amount of the PPA polymer blend, of the one or more fluoroelastomers. Moreover, the PPA polymer blend blend comprises from 40 to 60 wt. %, or from 45 to 55 wt. %, based on the total amount of the blend, of the polyethylene glycol.

As stated previously, the PPA polymer blend may be delivered in a composition comprising a polymer carrier, for example, a polymer carrier, and optionally other inorganic materials. As used herein, these embodiments are called PPA masterbatches. In specific embodiments, the PPA masterbatch may include a polyethylene carrier, for example, an LLDPE polymer carrier.

Inorganic Materials

Various inorganic materials are considered suitable for the PPA masterbatch. For example, the inorganic materials may comprise one or more selected from the group consisting of talc, calcium carbonate, mica, silicas, clay, inert metal oxides, magnesium oxide, and combinations thereof. In one embodiment, the inorganic materials may comprise talc and calcium carbonate.

As stated above, the PPA masterbatch may include up to 12 wt % of inorganic materials. In further embodiments, the PPA masterbatch may include from 0.5 to 8 wt % inorganic materials, or from 1 to 6 wt % inorganic materials.

Polyethylene

As stated previously, the composition comprises polyethylene, which could include a singular polyethylene or a blend of polyethylenes. The polyethylene may include ethylene α-olefin copolymer, ethylene homopolymer, or combinations thereof. The polyethylene (PE) may have a density ranging from 0.850 g/cc to 0.970 g/cc, or from 0.910 g/cc to 0.940 g/cc.

In some embodiments, the polyethylene comprises linear low density polyethylene (LLDPE). The LLDPEs can include Ziegler-Natta catalyzed linear low density polyethylene, and single site catalyzed (including metallocene) linear low density polyethylene. The polyethylene has a melt index (I₂) less than or equal to 5 g/10 minutes. All individual values and subranges from 5 g/10 minutes are included herein and disclosed herein. For example, the polyethylene can have an I₂ from an upper limit of 5, 4, 3.5, 3, 3.5, 2, 1.9, 1.8, 1.7, 1.6, 1.5, 1.4, 1.3, 1.2, or 1.1 g/10 minutes. Moreover, the polyethylene may have an I₂ with a lower limit of 0.3 g/10 minutes, 0.4, 0.45, or 0.5 g/10 minutes. Said another way, the polyethylene may have a melt index (I₂), as determined according to ASTM 1238D (190° C., 2.16 kg) of from 0.01 g/10 min to 5.0 g/10 min, from 0.01 to 3 g/10 mins, from 0.01 to 2 g/10 mins, or from 0.1-1.5 g/10 mins.

Fragrance Oil

In one or more embodiment, the composition may comprise from 500 to 5,000 ppm of the fragrance oil, or from 750 to 5,000 ppm, or from 1,000-5,000 ppm of the fragrance oil. Various fragrance oils and scents are contemplated suitable as would be familiar to the skilled person.

The present compositions are considered suitable for various applications. In one embodiment, the compositions may be utilized in blown films. In a specific embodiment, the blown film may be used in trash liners.

### Testing Methods

The test methods include the following:

Melt Index (I₂)

Melt index (I₂) were measured in accordance to ASTM D-1238 at 190° C. at 2.16 kg. The values are reported in g/10 min, which corresponds to grams eluted per 10 minutes.

Density

Samples for density measurement were prepared according to ASTM D4703 and reported in grams/cubic centimeter (g/cc or g/cm³). Measurements were made within one hour of sample pressing using ASTM D792, Method B.

Hansen Solubility Parameter (“HSP”)

Using the Hansen Solubility Parameter Experimental Procedure below, the solubility of several PPA masterbatches, fragrance oils, and an example of polyethylene were evaluated by placing each component into a separate series of solvents.

### Hansen Solubility Parameter Experimental Procedure:

Calculate solvent and active loading to have 5 wt % active in solvent, making sure to include the densities for each solvent (as listed in Table 1). Measure and combine each active in a separate vial with each separate solvent. That is, there should be 1 active and 1 solvent in each transparent vial.

Cap vials and agitate for 1 hour.

Let the samples sit for at least 40 hours

Rank each formulation by eye according to the following ranking system:

1. Soluble (that is, only one phase of material is visible in the vial)

2. Swollen (that is, two phases are visible in the vial, where the solid phase has appreciably increased in size)

3. Insoluble (that is, two phases are visible in the vial, and if a solid phase is present, it does not appreciably increase in size compared to the beginning of the experiment)

Use commercial software or calculate HSP parameters using ratings.

HSP parameters can be calculated using the equation listed below.

TABLE 1

| | | | | Hansen |
|---|---|---|---|---|
| | | Hansen | Hansen | Hydrogen |
| | | Dispersion | Polar | Bonding |
| | | (δd) | (δp) | (δh) |
| Solvent | Density | Parameter | Parameter | Parameter |
| Acetonitrile | 0.78 | 15.3 | 18 | 6.1 |
| Butyl Cellosolve | 0.90 | 16 | 7.6 | 12.3 |
| Dibutyl Ether | 0.77 | 15.3 | 3.4 | 3.3 |
| Dimethylformamide | 0.94 | 17.4 | 13.7 | 11.3 |
| Dimethylsulfoxide | 1.10 | 18.4 | 16.4 | 10.2 |
| Methanol | 0.79 | 15.1 | 12.3 | 22.3 |
| Methyl Ethyl Ketone | 0.81 | 16 | 9 | 5.1 |
| Methyl Isobutyl | 0.80 | 15.3 | 6.1 | 4.1 |
| Ketone | | | | |
| n-Butyl Acetate | 0.88 | 15.8 | 3.7 | 6.3 |
| n-heptane | 0.68 | 15.3 | 0 | 0 |
| n-propyl alcohol | 0.80 | 16 | 6.8 | 17.4 |
| o-Dichlorobenzene | 1.30 | 19.2 | 6.3 | 3.3 |
| Perchloroethylene | 1.62 | 18.3 | 5.7 | 0 |
| Propylene Carbonate | 1.20 | 20 | 18 | 4.1 |
| Propylene Glycol | 1.04 | 16.8 | 9.4 | 23.3 |
| Tetrahydrofuran | 0.89 | 16.8 | 5.7 | 8 |
| Toluene | 0.87 | 18 | 1.4 | 2 |
| Water | 1.00 | 19.5 | 17.8 | 17.6 |

Density is in units: g/cm³and all Hansen solubility parameters are in units MPa^{1/2}.

The HSP is calculated according to the methodology provided in: Javier Camacho, Eduardo Díez, Ismael Díaz, and Gabriel Ovejero; Hansen solubility parameter: from polyethylene and poly(vinyl acetate) homopolymers to ethylene-vinyl acetate copolymers; Polymer Intl., 2017; 66: 1013-1020.

“In the literature have been described several methods which can be used to calculate HSP values. One of them was proposed by Skaarup, who developed an equation to determine the ‘distance’, Ra, between a solvent (subscript 1) and a polymer (subscript 2), based on their respective partial solubility parameter components:

(Ra)²=4(δd2−δd1)²+(δp2−δp1)²+(δh2−δh1)²

In this equation, which developed from plots of experimental data, the constant 4 was found convenient. It was capable of correctly representing the solubility data, where δd, δp and δh are the center of a HSP sphere plotted in a Cartesian space. Ra should not exceed a certain ‘radius of interaction’ Ro in the solubility sphere of a polymer for good solvents (both Ra and Ro have the same units as solubility parameter). The ratio Ra/Ro is called relative energy difference (RED) and it is useful for a quick evaluation of whether a solvent is likely to appear inside the solubility sphere of a polymer. Non-solvents will have RED values greater than 1, while solvents will have RED values less than or equal to 1.”

The Ro is defined as the Ra of the PPA, is derived from the above equation for each polymer based on the known HSP parameters for each solvent listed in Table 1.

### EXAMPLES

The following examples illustrate features of the present disclosure but are not intended to limit the scope of the disclosure. Table 2 lists PPA masterbatches used in the examples.

TABLE 2

| | Wt. % in PPA of | Mol % of | | Wt. % | |
|---|---|---|---|---|---|
| | Fluoroelastomer | vinylidene | Mol % of | in PPA | Wt % in |
| | (vinylidene fluoride- | fluoride | hexafluoropropylene | of Poly- | PPA of |
| | hexafluoropropylene | monomer in | monomer in | ethylene | Inorganic |
| PPA | copolymer) | Fluoroelastomer | Fluoroelastomer | Glycol | Oxides |
| Dynamar ™ | 70% | — | — | 30% | Up to 2 |
| FX 5920 | | | | | wt % |
| Dynamar ™ | 52.7% | 78% | 22% | 46.7% | Up to 2 |
| FX 5929 | | | | | wt % |

Dynamar™ FX 5920 and Dynamar™ FX 5929, which are both commercially available PPA masterbatches available from 3M™, comprise PPA at 8 wt % in a DOWLEX™ 2047 carrier resin. DOWLEX™ 2047 LLDPE resin, which was used as a carrier resin and studied separately, has a density of 0.917 g/cc, and a melt index (I₂) of 2.3 g/10 min. DOWLEX™ 2047 is produced by The Dow Chemical Company, Midland, Mich. The fragrance oils were the ArtMinds™ Apple Blossom Fragrance Oil and Orange Fragrance Oil products supplied by Michaels Stores.

In the following examples listed in Table 3, the PPA masterbatch, PE and the fragrance oils were mixed separately with the solvents from Table 1. The Ra was calculated for each PPA masterbatch, fragrance oil, and PE. RED values were calculated for each fragrance oil and the polyethylene as compared to the Ra of the PPA masterbatch, where the Ra for the Dynamar™ FX 5920 was determined to be 9.1, and 14.5 for the Dynamar™ FX 5929, respectively. RED is the Ra for either the fragrance oil or PE divided by the Ra for the appropriate PPA masterbatch. Table 3 below summarizes these results for these experiments.

TABLE 3

| Example | | Resin or Fragrance | | |
|---|---|---|---|---|
| Number | PPA Candidate | Oil | Ra | RED |
| Comparative | Dynamar 5920 | Fragrance Oil: Apple | 7.2 | 0.8 |
| Example 1 | | | | |
| Comparative | Dynamar 5920 | DOWLEX ™ 2047 | 15.9 | 1.8 |
| Example 1 | | | | |
| Inventive | Dynamar 5929 | Fragrance Oil: Apple | 13.9 | 1.0 |
| Example 1 | | | | |
| Inventive | Dynamar 5929 | DOWLEX ™ 2047 | 3.6 | 0.2 |
| Example 1 | | | | |
| Comparative | Dynamar 5920 | Fragrance Oil: | 7.7 | 0.8 |
| Example 2 | | Orange | | |
| Comparative | Dynamar 5920 | DOWLEX ™ 2047 | 15.9 | 1.8 |
| Example 2 | | | | |
| Inventive | Dynamar 5929 | Fragrance Oil: | 13.4 | 0.9 |
| Example 2 | | Orange | | |
| Inventive | Dynamar 5929 | DOWLEX ™ 2047 | 3.6 | 0.2 |
| Example 2 | | | | |

As shown in Table 3, the RED for Inventive Examples 1 and 2 are lower for PE than it is for the fragrance oil, whereas the RED for Comparative Examples 1 and 2 is lower for the fragrance oil than it is for the polyethylene. Inventive Examples 1 and 2 included Dynamar™ FX 5929, which contained between 40 to 60 wt % fluoroelastomer, 40 to 60 wt % polyethylene glycol, and inorganic materials such as talc, calcium carbonate, and/or magnesium oxide. As a result, Inventive Examples 1 and example 2 satisfied the equation: RED (_{PE-PPA masterbatch})<RED (_{Fragrance Oil-PPA masterbatch}). In contrast, Comparative Examples 1 and 2 included Dynamar™ FX 5920, which had less than 40 wt % polyethylene glycol, and yielded a lower RED for the fragrance oil than the PE. As a result, the PPA would not be able to effectively migrate to the polymer/melt processing equipment interface during the blown film extrusion process.

It will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects.

1. A composition comprising:
at least one polyethylene (PE) having a density ranging from 0.850 g/cc to 0.970 g/cc;
a polymer processing aid (PPA) masterbatch comprising a PPA polymer blend, at least one polymeric carrier, and optionally up to 12 wt. % of one or more inorganic materials, wherein the PPA polymer blend comprises:
from 40 to 60 wt. %, based on the total amount of the PPA polymer blend, of one or more fluoroelastomers;
from 40 to 60 wt. %, based on the total amount of the PPA polymer blend, of polyethylene glycol; and
at least one fragrance oil;
wherein the composition is defined by the equation:
RED (_{PE-PPA masterbatch})<RED (_{Fragrance Oil-PPA masterbatch}),
wherein the RED (_{PE-PPA masterbatch}) is the relative energy difference (RED) value for the PE and PPA masterbatch and RED (_{Fragrance Oil-PPA masterbatch}) is the RED value for the fragrance oil and PPA masterbatch.

2. The composition of claim 1, wherein the composition comprises from 100 to 2,000 ppm of the PPA polymer masterbatch.

3. The composition of claim 1, wherein the one or more fluoroelastomers comprise a copolymer of vinylidene fluoride and hexafluoropropylene.

4. The composition of claim 1, wherein the composition comprises from 500 ppm to 5,000 ppm of the fragrance oil.

5. The composition of claim 1, wherein the PPA polymer blend comprises:
from 45 to 55 wt. %, based on the total amount of the PPA polymer blend, of the one or more fluoroelastomers; and
from 45 to 55 wt. %, based on the total amount of the blend, of the polyethylene glycol.

6. The composition of claim 1, wherein the inorganic materials comprise one or more selected from the group consisting of talc, calcium carbonate, mica, silicas, clay, inert metal oxides, magnesium oxide, and combinations thereof.

7. The composition of claim 1, wherein the polyethylene has a density ranging from 0.910 g/cc to 0.940 g/cc.

8. The composition of claim 1, wherein the polyethylene has a melt index (I₂), as determined according to ASTM 1238D (190° C., 2.16 kg) of from 0.01 g/10 min to 5.0 g/10 min.

9. A blown film produced from the composition of claim 1.

10. A trash liner formed from the blown film of claim 9.

11. The composition of claim 1, wherein the PPA polymer blend comprises:
from 45 to 55 wt. %, based on the total amount of the PPA polymer blend, of the one or more fluoroelastomers; and
from 45 to 55 wt. %, based on the total amount of the blend, of the polyethylene glycol, and
the polyethylene has a density ranging from 0.910 g/cc to 0.940 g/cc.

12. The composition of claim 11, wherein the polyethylene has a melt index (I₂), as determined according to ASTM 1238D (190° C., 2.16 kg) of from 0.01 g/10 min to 5.0 g/10 min.

13. The composition of claim 12, wherein the composition comprises from 100 to 2,000 ppm of the PPA polymer masterbatch.

14. The composition of claim 12, wherein the one or more fluoroelastomers comprise a copolymer of vinylidene fluoride and hexafluoropropylene.

15. The composition of claim 12, wherein the composition comprises from 500 ppm to 5,000 ppm of the fragrance oil.
